(19) United States
(12) Patent Application Publication
(10) Pub. No.: US 2009/0090708 A1
(43) Pub. Date: Apr. 9, 2009

(54) Microwave Heating Sleeve

(76) Inventors: Emili Requena, Igualada (ES); Jordi Sambola, Igualada (ES); Josep Cano, Castelloli (ES)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/243,025

(22) Filed: Oct. 1, 2008

Related U.S. Application Data
(60) Provisional application No. 60/997,487, filed on Oct. 3, 2007.

(51) Int. Cl. H05B 6/80

(52) U.S. Cl. 219/730

(57) ABSTRACT

A microwave energy interactive sleeve, a blank for forming the sleeve, and a method of packaging a food item to be heated, browned, and/or crisped is provided. The food item may be enwrapped in the sleeve as the sleeve is being erected such that a frozen or unfrozen food item may be loaded into the sleeve without significantly damaging the food item.

### CROSS-REFERENCE TO RELATED APPLICATIONS

This application claims the benefit of U.S. Provisional Application No. 60/997,487, filed Oct. 3, 2007, which is incorporated by reference herein in its entirety.

### TECHNICAL FIELD

The present disclosure relates to various blanks, constructs, and methods for heating, browning, and/or crisping a food item, and particularly relates to various blanks, constructs, and methods for heating, browning, and/or crisping a food item in a microwave oven.

### BACKGROUND

Microwave ovens provide a convenient means for heating a variety of food items, including dough-based products such as pizzas, pies, and sandwiches. However, microwave ovens tend to cook such items unevenly and are unable to achieve the desired balance of thorough heating and a browned, crisp bread or crust. As a result, many packages have been developed with microwave energy interactive features that enhance the heating, browning, and/or crisping of the food item. Such packages often are dimensioned to provide a relatively close fit between the food item and the microwave energy interactive features.

Prior to heating, the consumer typically unwraps the food item, which often is frozen, and places the food item into the package in proximate and/or intimate contact with the microwave energy interactive features. Unfortunately, this approach may be unsuitable for use with food items that are not frozen, for example, sandwiches, because such items may lack the stiffness and durability required to be inserted into the package without tearing or otherwise damaging the bread.

Thus, there is a continuing need for a method of packaging an unfrozen food item intended to be heated, browned, and/or crisped in a microwave oven. There also is a continuing need for a microwavable package that provides the desired degree of heating, browning, and/or crisping of the outer surface of a food item, whether the food item is frozen or unfrozen.

### SUMMARY

The present disclosure is directed generally to various blanks, constructs formed from such blanks, methods of making such blanks and constructs, and methods of packaging or containing a food item. The various constructs are adapted to receive a food item when the construct is in a first, at least partially open configuration, and to enwrap the food item to form a somewhat rigid or semi-rigid construct having a second, at least partially closed configuration. In this manner, frozen or unfrozen food items may be loaded into the interior space of semi-rigid construct without damaging the outer portions (e.g., the bread or crust) of the food item. The construct may include one or more features that secure the construct in a closed or locked configuration with the food item positioned somewhat snugly within the interior space.

The construct may be formed from a disposable material, for example, paperboard, and may be used to prepare various food items in a microwave oven, for example, sandwiches, savory or sweet pastries, breaded food items, or any other food item that desirably is heated, browned, and/or crisped.

If desired, the construct may include one or more microwave energy interactive elements that alter the effect of microwave energy on the adjacent food item. Each microwave energy interactive element comprises one or more microwave energy interactive materials or segments arranged in a particular configuration to absorb microwave energy, transmit microwave energy, reflect microwave energy, or direct microwave energy, as needed or desired for a particular microwave heating construct and food item. In one example, the microwave energy interactive element comprises a susceptor, i.e., a thin layer of microwave energy interactive material (generally less than about 100 angstroms in thickness, for example, from about 60 to about 100 angstroms in thickness) that tends to absorb at least a portion of impinging microwave energy and convert it to thermal energy (i.e., heat) at the interface with the food item. Susceptor elements often are used to promote browning and/or crisping of the surface of a food item. When supported on a film or other substrate, a susceptor element may be referred to as a “susceptor film” or, sometimes simply, “susceptor”. However, other microwave energy interactive elements may be used.

Alternatively or additionally, the various constructs may include one or more features that elevate a food item from the turntable and/or the interior floor of the microwave oven. By elevating the food item in this manner, more heat may be retained by and/or directed to the food item, rather than being lost to the turntable or to the floor of the microwave oven. As a result, the microwave heating efficiency may be improved significantly.

Other features, aspects, and embodiments will be apparent from the following description and accompanying figures.

### BRIEF DESCRIPTION OF THE DRAWINGS

The description refers to the accompanying drawings in which like reference characters refer to like parts throughout the several views, and in which:

FIG. 1A is a schematic perspective view of an exemplary construct (e.g., a sleeve) for heating, browning, and/or crisping a food item in a microwave oven;

FIG. 1B is a schematic perspective view of the construct of FIG. 1A in a partially erected configuration;

FIG. 1C is a schematic top plan view of an exemplary blank that may be used to form the construct of FIG. 1A;

FIG. 2A is a schematic perspective view of another exemplary construct (e.g., a sleeve) for heating, browning, and/or crisping a food item in a microwave oven; and

FIG. 2B is a schematic top plan view of an exemplary blank that may be used to form the construct of FIG. 2A.

### DESCRIPTION

The present invention may be understood further by referring to the figures. For simplicity, like numerals may be used to describe like features. It will be understood that where a plurality of similar features are depicted, not all of such features necessarily are labeled on each figure. It also will be understood that various components used to form the blanks and constructs of the present invention may be interchanged. Thus, while only certain combinations are illustrated herein, numerous other combinations and configurations are contemplated hereby.

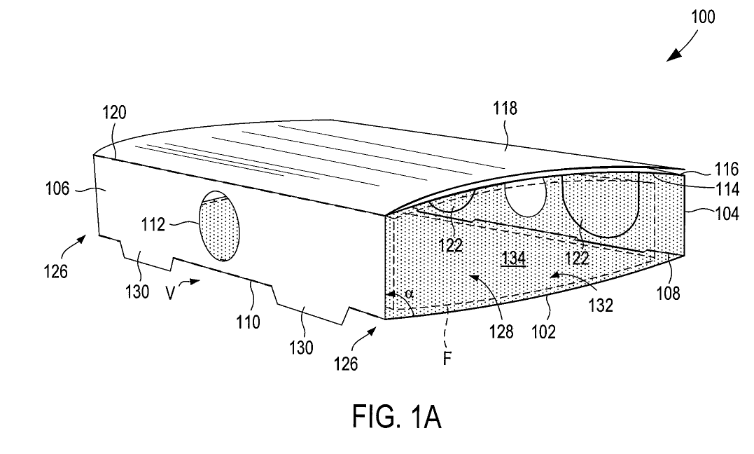

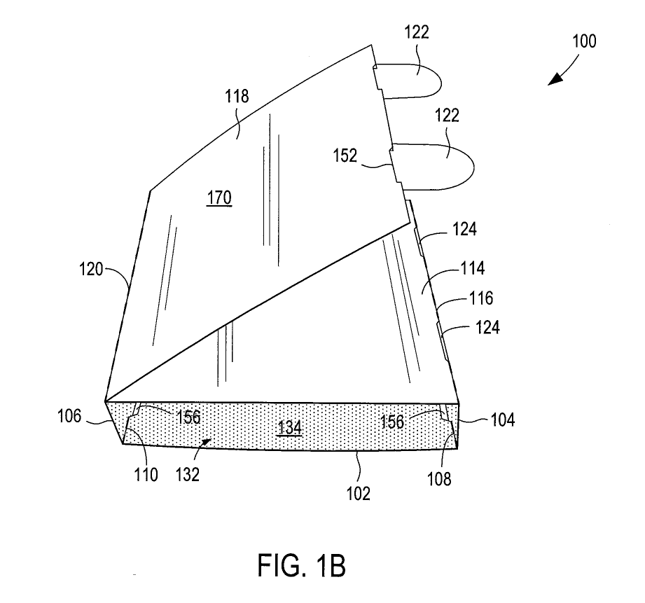

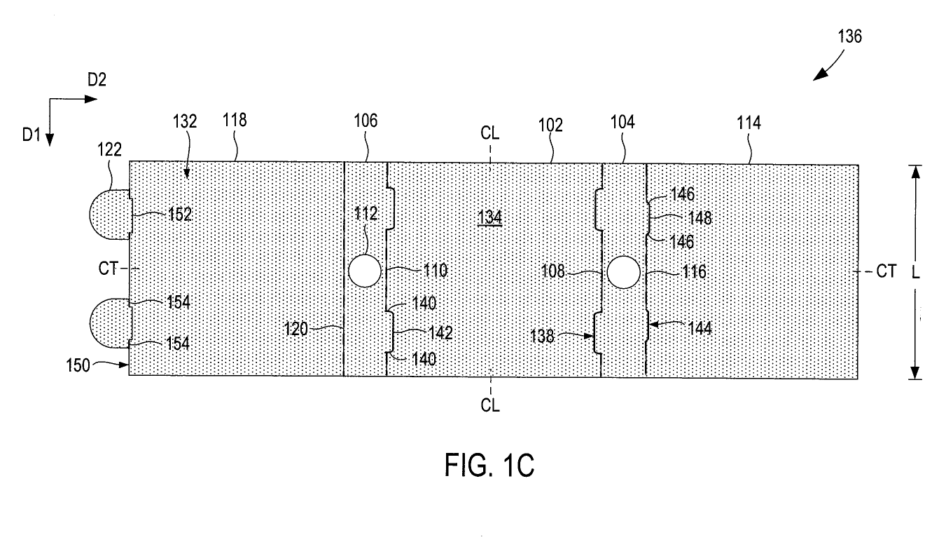

FIG. 1A is a schematic perspective view of an exemplary construct 100 (e.g., sleeve 100) for heating, browning, and/or crisping a food item in a microwave oven. The construct 100 includes a platform or base panel 102 on which a food item F (shown schematically with dashed lines in FIG. 1A) may be seated. The base panel 102 has a substantially planar construction, such that the base panel 102 can be said to lie within a substantially horizontal theoretical plane. However, it will be understood that depending on the material used to form the base panel 102 and the particular food item seated on the base panel 102, the base panel 102 may flex downwardly somewhat, for example, along the longitudinal centerline CL of the base panel 102 (FIG. 1C), or may otherwise bend or twist to accommodate the shape and/or weight of the food item. Thus, it will be understood that the “plane” of the base panel or platform 102 (or any other panel) refers an approximation of the plane in which the base panel or platform generally lies and should not be bound to strict or precise mathematical definitions, calculations, or measurements.

In this example, the base panel 102 has a generally square shape suitable, for example, for seating a sandwich thereon. However, it will be understood that numerous other suitable shapes and configurations may be used to form the base panel 102. Examples of other shapes encompassed hereby include, but are not limited to, polygons, circles, ovals, or any other regular or irregular shape. The shape of the base panel 102 may be determined by the shape of the food item, and it should be understood that different constructs are contemplated for different food items, for example, sandwiches, pizzas, French fries, soft pretzels, pizza bites, cheese sticks, pastries, doughs, and so forth. The base panel 102 may be sized and shaped to receive one portion or multiple portions of one or more different food items.

Still viewing FIG. 1A, a pair of side panels or walls 104, 106 are foldably joined to the base panel 102 along respective lines of disruption, for example, respective fold lines 108, 110 disposed along a pair of substantially opposed or opposite edges of the base panel 102. The side panels 104, 106 extend generally upwardly from the base panel 102, and may, in some instances, be substantially perpendicular to the base panel 102. However, the side walls may form various specific angles a with respect to the plane of the base panel 102.

If desired, the sleeve 100 may include one or more venting apertures 112 that allow water vapor or other gases to diffuse away from the food item F during heating, thereby improving the browning and/or crisping of the food item F. In this example, each side panel 104, 106 includes an aperture 112 substantially centrally located along the length L of the base panel 102. In this example, each aperture 112 is substantially circular in shape. However, it will be understood that the number, shape, spacing, and positioning of the apertures may vary depending on the food item to be heated and the desired degree of browning and crisping, as will be discussed further below.

Still viewing FIG. 1A, the sleeve 100 includes a first, inner top panel or wall 114 foldably joined to side panel 104 along a line of disruption, for example, fold line 116. In this example, the inner top panel 114 extends substantially between the side panels 104, 106 in a substantially opposed, substantially parallel relationship to the base panel 102. The sleeve 100 also includes a second, outer top panel or wall 118 foldably joined to side panel 106 along a line of disruption, for example, fold line 120. The outer top panel 118 extends substantially between the pair of opposed side panels 104, 106 in a substantially opposed, substantially parallel relationship to the base panel 102, and a substantially contacting, facing relationship with the inner top panel 114. The outer top panel 118 is secured in a locked position by at least one locking feature, in this example, a pair of tabs 122 engaged with a receptacle, for example, respective receiving slots 124, disposed within the inner top panel 114 proximate to fold line 116 (best seen FIG. 1B, which illustrates the sleeve 100 in a partially erected configuration). In the locked position, the tabs 122 are in a substantially contacting, face-to-face relationship with the interior surface of side panel 104 (FIG. 1A). The base panel 102, side panels 104, 106, and top panels 114, 118 define a sleeve 100 with a pair of open ends 126 and a cavity 128 for receiving the food item F.

While some configurations of locking features and receiving slots are provided herein, other configurations are contemplated. For example, it will be understood that some or all of the inner top panel 114 may be omitted and the receiving slots 124 may be formed in the side panel 104 or in another suitable location.

As illustrated schematically in FIG. 1A, a plurality of substantially upright support elements 130 (only two of which are visible in FIG. 1A) elevate the sleeve 100 from a surface on which the sleeve is seated, for example, the floor or turntable of a microwave oven (not shown). The support elements 130 generally maintain the base 102 in an elevated position and at least partially define a void V beneath the base 102.

If desired, a microwave energy interactive element 132 (shown schematically by stippling) may overlie, may be joined to, and/or may define at least a portion of a food-contacting side or surface 134 of any of the base panel 102, side panels 104, 106, top panels 114, 118, and tabs 122. In one example, the microwave energy interactive element comprises a susceptor that promotes browning and/or crisping of an outer surface of an adjacent food item. However, other microwave energy interactive elements, such as those described below, may be used. If desired, a second surface 170 (FIGS. 1A and 1B) opposite the first surface 134 also may include one or more microwave energy interactive elements (not shown).

To use the sleeve 100 according to one exemplary method, a food item F may be provided on or placed on the base panel 102 between the side panels 104, 106 and top panels 114, 118 to maximize contact between the food item and the microwave energy interactive element 132 overlying and/or defining at least a portion of the interior surface 134 of the sleeve 100. The base panel 102 may flex slightly to accommodate the contours of the bottom of the food item.

During heating, the microwave energy interactive element 132 overlying the interior surface of the sleeve 100, in this example, a susceptor, converts at least a portion of impinging microwave energy to thermal energy to enhance the heating, browning, and/or crisping of the surface of the food item, for example, the bread of a sandwich. Where panels 114, 118 overlap, additional heat may be generated, which may further enhance the heating, browning, and/or crisping of the adjacent surface of the food item F.

Notably, since the inner top panel 114 is not joined directly to outer top panel 118 or side panel 104, it is able to hinge upwardly or downwardly along fold line 120, the movement of the inner top panel 114 generally being bound by the upper surface of the food item F and the interior side of the outer top panel 118. As a result, as the food item F heats, the inner top panel 114 can hinge, move, flex, or “float” upwardly or downwardly with the expansion or contraction of the food item F. For example, where the food item is a sandwich with cheese, the height of the sandwich may decrease as the cheese melts. Prior to heating, the inner top panel 114 may rest on (or be disposed close to) the top of the sandwich. As the height of the sandwich decreases, the inner top panel 114 may drop downwardly, thereby maintaining the susceptor 132 in proximate and/or intimate contact with the sandwich.

Further, by maintaining the food item in an elevated position on the base panel 102, the air in the void V between the base panel 102 and the floor of the microwave oven may provide an insulating effect, thereby decreasing the amount of heat loss from the microwave energy interactive material of the susceptor 132 to the floor of the microwave oven. As a result, the heating of the food item and the browning and/or crisping of the top, bottom, and sides of the food item may be enhanced further. Additionally, the venting apertures 112 allow water vapor or other gases to diffuse away from the food item during heating, which also may improve the browning and/or crisping of the food item.

FIG. 1C depicts a schematic top plan view of an exemplary blank 136 that may be used to form the construct 100 of FIG. 1A. The blank 136 includes a plurality of panels joined along lines of disruption, for example, fold lines, score lines, or other lines of weakening. The blank 136 and each of the various panels generally has a first dimension, for example, a length, extending in a first direction, for example, a longitudinal direction, D1, and a second dimension, for example, a width, extending in a second direction, for example, a transverse direction, D2, substantially perpendicular to the first direction. It will be understood that such designations are made only for convenience and do not necessarily refer to or limit the manner in which the blank is manufactured or erected into the construct. The blank 136 may be symmetric or nearly symmetric about a transverse centerline CT. Therefore, certain elements in the drawing figures may have similar or identical reference numerals to reflect the whole or partial symmetry.

As illustrated schematically in FIG. 1C, the blank 136 generally includes a main panel or base panel 102, a pair of side panels 104, 106, and a pair of top panels 114, 118. Each side panel 104, 106 is joined to the base panel 102 along a respective line of disruption, for example, longitudinal fold lines 108, 110, each of which is interrupted by respective pairs of cuts or slits 138. Each cut or slit 138 includes a pair of somewhat curved transverse portions 140 extending into the base panel 102 from the respective fold line 108, 110 and a substantially linear portion 142 extending in the longitudinal direction between the transverse portions 140, such that each slit 138 generally has a somewhat squared or flattened C-shape and/or U-shape, although other shapes are within the scope of the invention.

Similarly, side panel 104 is joined to the first top panel 114 along a line of disruption, for example, longitudinal fold line 116, interrupted by cuts or slits 144. Each slit 144 includes a pair of substantially opposed, converging oblique portions 146 extending into the first top panel 114 from fold line 116 and a substantially linear portion 148 extending in the longitudinal direction between the oblique portions 146, such that each slit 144 generally has a somewhat squared or flattened, somewhat opened and angular C-shape and/or U-shape, although other shapes are within the scope of the disclosure. In this example, slits 144 lie closer to the transverse centerline CT of the blank 136 than slits 138. However, other configurations in which slits 138, 144 are aligned or misaligned are contemplated by the invention.

Each side panel 104, 106 includes a circular aperture 112 substantially centered in the transverse and longitudinal directions. However, other arrangements are encompassed by the invention.

The second top panel 118 is joined to side panel 106 along a line of disruption, in this example, longitudinal fold line 120. A pair of tabs 122 extends from an edge 150 of the second top panel 118 along respective lines of disruption, for example, fold lines 152. In this example, each tab 122 is somewhat rounded in shape. However, other shaped tabs 122 may be used if desired. Optionally, tabs 122 may be partially separated from the second top panel 118 by respective edge cuts 154, which facilitate folding of the tabs 122 along respective fold lines 152 and/or assist with locking the tabs 122 in the respective receiving slots 124 (FIG. 1B).

A microwave energy interactive element 132 (shown schematically by stippling), for example, a susceptor, may overlie all or a portion of one or more of the various panels of the blank 136. In the illustrated example, the microwave energy interactive element 132 overlies substantially all of one side of the blank 136 and at least partially defines a food-contacting surface 134 of the sleeve 100 formed from the blank 136.

According to one exemplary method of forming of the blank 136 into the sleeve 100, panels 104, 106 may be folded along fold lines 108, 110 and brought into a substantially upright configuration. In doing so, the support elements 130, which are defined by slits 138, are struck from the respective adjacent portions of the base panel 102, thereby forming respective voids or apertures 156 in the base panel 102 (FIG. 1B). In this configuration, the support elements 130 extend substantially downwardly from the respective side panel 104, 106 below the plane of the base panel 102 to elevate the base panel 102 from a surface on which the sleeve 100 is seated. It is noted that during use, apertures 156 may serve as venting apertures to enhance the heating, browning, and/or crisping of the food item.

The food item (not shown) then may be placed on the base panel 102. Alternatively, the food item may be placed on the base panel 102 before folding the side panels 104, 106 upwardly. In either case, the present invention seeks to allow a more fragile food item, for example, an unfrozen food item, to be loaded into the microwave heating package or sleeve 100 without damaging the food item. It will be understood that, if desired, a more rigid food item may be able to be loaded into the sleeve 100, for example, after the sleeve is formed.

The top panels 114, 118 may be folded along respective fold lines 116, 120 and brought into a substantially overlapping, superposed arrangement with both panels 114, 118 being substantially parallel to the platform or base panel 102. When the partially erected construct is folded along fold line 116, a portion of the first, inner top panel 114 adjacent to slits 144 is struck to define receptacles (e.g. receiving slots) 124 for the tabs 122 (FIG. 1B). The tabs 122 then may be inserted into the receiving slots 124 to form the construct or sleeve 100 of FIG. 1A. If desired, the food item within the sleeve 100 may be wrapped with an overwrap (not shown). Such an overwrap may provide barrier properties, and in one example, may provide an oxygen transmission rate of less than about 10 cc/m²/day/atm.

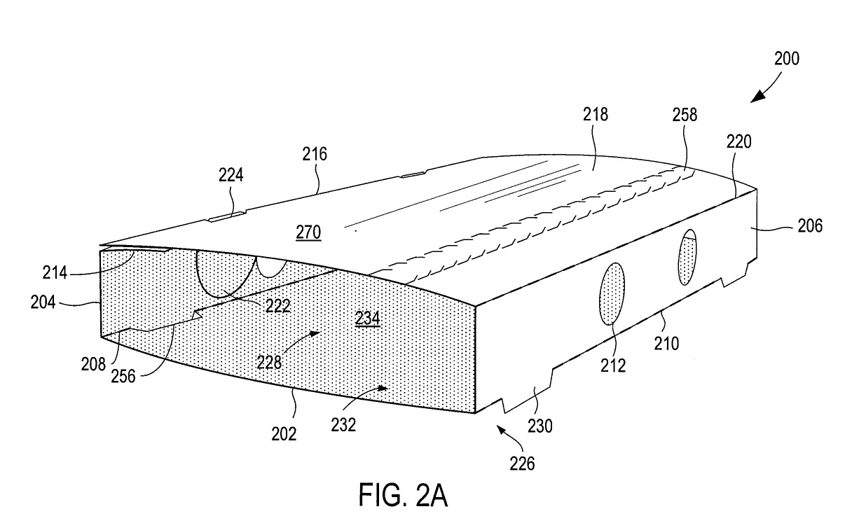

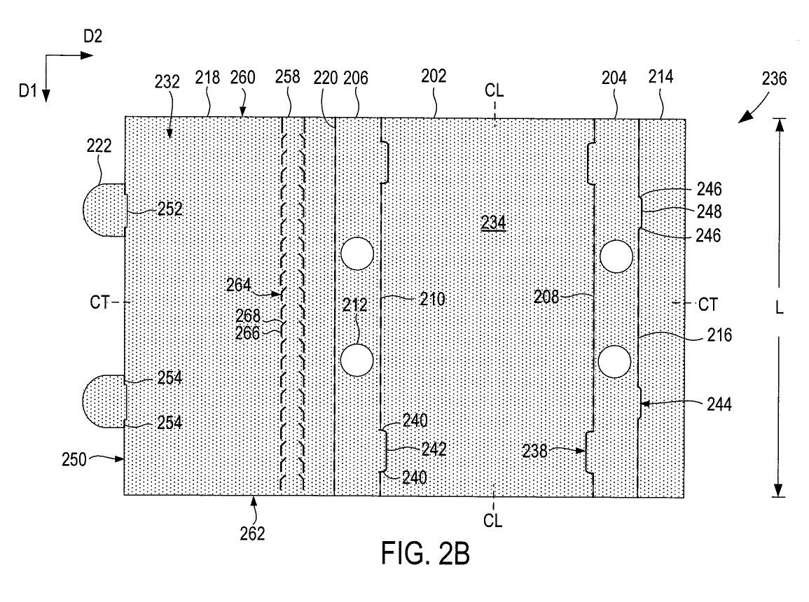

FIG. 2A illustrates another exemplary construct according to various aspects of the invention. In this example, the construct is a sleeve 200 having a substantially rectangular shape, suitable for heating a sandwich or other elongated food item. The sleeve 200 may include features that are similar to the sleeve 100 shown in FIGS. 1A and 1B, except for variations noted and variations that will be understood by those of skill in the art. For purposes of simplicity and not limitation, the reference numerals of similar features are preceded in the figures with a “2” instead of a “1”.

In this example, the inner top panel 214 extends only partially between the opposed side panels or side walls 204, 206. Furthermore, the sleeve 200 includes a tear strip 258 extending in the longitudinal direction between opposed edges 260, 262 of the second, outer top panel 218 to facilitate removal of the food item after heating. In this example, best understood with reference to FIG. 2B, the tear strip 258 is defined by one or more tear lines, each including a plurality of spaced cuts 264. In this example, each cut 264 includes a substantially linear longitudinal portion 266 and a substantially linear oblique portion 268 (sometimes collectively referred to as a “zipper” cut). However, other tear strip configurations are contemplated hereby.

FIG. 2B schematically illustrates an exemplary blank 236 for forming the sleeve 200 of FIG. 2A. The blank 236 may be formed into the sleeve 200 using any suitable sequence of steps, for example, as described above in connection with FIGS. 1A-1C.

Numerous other microwave heating constructs are encompassed by the invention. Any of such structures described herein or contemplated hereby may be formed from various materials, provided that the materials are substantially resistant to softening, scorching, combusting, or degrading at typical microwave oven heating temperatures, for example, at from about 250° F. to about 425° F. The particular materials used may include microwave energy interactive materials, for example, those used to form susceptors and other microwave energy interactive elements, and microwave energy transparent or inactive materials, for example, those used to form the remainder of the construct.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymer film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

While susceptors are described in detail herein with the illustrated exemplary constructs 100, 200, the microwave energy interactive element 132, 232 alternatively or additionally may comprise a foil having a thickness sufficient to shield one or more selected portions of the food item from microwave energy. Such “shielding elements” may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one example, the shielding element may have a thickness of from about 0.0003 inches to about 0.03 inches. In another example, the shielding element may have a thickness of from about 0.00035 inches to about 0.020 inches, for example, about 0.016 inches.

As still another example, the microwave energy interactive element may comprise a segmented foil, such as, but not limited to, those described in U.S. Pat. Nos. 6,204,492, 6,433,322, 6,552,315, and 6,677,563. Although segmented foils are not continuous, appropriately spaced groupings of such segments may act as a shielding element. Such foils also may be used in combination with susceptor elements and, depending on the configuration and positioning of the segmented foil, the segmented foil may operate to direct microwave energy and promote heating rather than to shield microwave energy.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The breaks or apertures may extend through the entire structure, or only through one or more layers. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in one or more layers or materials used to form the construct, or may be a non-physical “aperture”. A non-physical aperture is a microwave energy transparent area that allows microwave energy to pass through the susceptor layer without an actual void or hole cut through the structure. Such areas may be formed by simply not applying a microwave energy interactive material to the particular area, or by removing microwave energy interactive material in the particular area, or by chemically and/or mechanically deactivating the microwave energy interactive material in the particular area. While both physical and non-physical apertures allow the food item to be heated directly by the microwave energy, a physical aperture also provides a venting function to allow steam or other vapors to escape from the interior of the construct. It will be noted that where chemical deactivation is used, the metal in the deactivated area may be chemically altered, for example, oxidized, such that the non-physical aperture comprises a chemically altered, but microwave energy transparent, form of the metal.

The arrangement of microwave energy interactive and microwave energy transparent areas may be selected to provide various levels of heating, as needed or desired for a particular application. For example, where greater heating is desired, the total inactive area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance browning and/or crisping.

In some instances, it may be beneficial to create one or more discontinuities or inactive regions to prevent overheating or charring of the construct. By way of example, and not limitation, in the sleeves 100, 200 respectively illustrated in FIGS. 1A and 2A, the inner top panel 114, 214 and the outer top panel 118, 218 are overlapped and in intimate and/or proximate contact with one another. When exposed to microwave energy, the concentration of heat generated by the overlapped panels may be sufficient to cause the underlying support, in this case, paperboard, to become scorched. As such, the portion of the outer top panel 118, 218 that overlaps with the inner top panel 114, 214 may be designed to be microwave energy transparent, for example, by forming this area of the blank 136, 236 or construct 100, 200 without a microwave energy interactive material, by removing any microwave energy interactive material that has been applied, or by deactivating the microwave energy interactive material in these areas.

Further still, one or more panels, portions of panels, or portions of the construct may be designed to be microwave energy inactive to ensure that the microwave energy is focused efficiently on the areas to be browned and/or crisped, rather than being lost to portions of the food item not intended to be browned and/or crisped or to the heating environment. This may be achieved using any suitable technique, such as those described above.

If desired, the microwave energy interactive element may be supported on a microwave inactive or transparent substrate, for example, a polymer film or other suitable polymeric material, for ease of handling and/or to prevent contact between the microwave energy interactive material and the food item. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

Examples of polymer films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one particular example, the polymer film comprises polyethylene terephthalate. Examples of polyethylene terephthalate films that may be suitable for use as the substrate include, but are not limited to, MELINEX®, commercially available from DuPont Teijan Films (Hopewell, Va.), and SKYROL, commercially available from SKC, Inc. (Covington, Ga.). Polyethylene terephthalate films are used in commercially available susceptors, for example, the QWIKWAVE® Focus susceptor and the MICRORITE® susceptor, both available from Graphic Packaging International (Marietta, Ga.).

The thickness of the film generally may be from about 35 gauge to about 10 mil. In each of various examples, the thickness of the film may be from about 40 to about 80 gauge, from about 45 to about 50 gauge, about 48 gauge, or any other suitable thickness.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

For example, the microwave energy interactive material may be provided as a continuous or discontinuous layer or coating including circles, loops, hexagons, islands, squares, rectangles, octagons, and so forth. Examples of various patterns and methods that may be suitable for use with the present invention are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5,221,419; 5,213,902; 5,117,078; 5,039,364; 4,963,424; 4,936,935; 4,890,439; 4,775,771; 4,865,921; and Re. 34,683. Although particular examples of patterns of microwave energy interactive material are shown and described herein, it should be understood that other patterns of microwave energy interactive material are contemplated by the present invention.

Various materials may serve as the base material for the construct. For example, all or a portion of the construct may be formed at least partially from a paper or paperboard material. In one example, the paper has a basis weight of from about 15 to about 60 lbs/ream (lb/3000 sq. ft.), for example, from about 20 to about 40 lbs/ream. In another example, the paper has a basis weight of about 25 lbs/ream. In another example, the paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International.

As another example, the construct may be formed at least partially from a polymer or polymeric material. Examples of other polymers that may be suitable for use with the present invention include, but are not limited to, polycarbonate, polyolefins, e.g. polyethylene, polypropylene, polybutylene, and copolymers thereof; polytetrafluoroethylene; polyesters, e.g. polyethylene terephthalate, e.g., coextruded polyethylene terephthalate; vinyl polymers, e.g., polyvinyl chloride, polyvinyl alcohol, ethylene vinyl alcohol, polyvinylidene chloride, polyvinyl acetate, polyvinyl chloride acetate, polyvinyl butyral; acrylic resins, e.g. polyacrylate, polymethylacrylate, and polymethylmethacrylate; polyamides, e.g., nylon 6,6; polystyrenes; polyurethanes; cellulosic resins, e.g., cellulosic nitrate, cellulosic acetate, cellulosic acetate butyrate, ethyl cellulose; copolymers of any of the above materials; or any blend or combination thereof.

The various constructs of the invention may be formed according to numerous processes known to those in the art, including using adhesive bonding, thermal bonding, ultrasonic bonding, mechanical stitching, or any other suitable process. Any of the various layers that may be used to form the constructs of the invention may be provided as a sheet of material, a roll of material, or a die cut material in the shape of the construct to be formed (e.g., a blank).

Optionally, one or more panels of the various constructs described herein or contemplated hereby may be coated with varnish, clay, or other materials, either alone or in combination. The coating may then be printed over with product advertising or other information or images. The constructs also may be coated to protect any information printed thereon. Furthermore, the constructs may be coated with, for example, a moisture barrier layer, on either or both sides.

Alternatively or additionally, any of the structures or constructs of the present invention may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. Patent Application Publication No. US 2006/0049190 A1, published Mar. 9, 2006. Additionally, the structures or constructs may include graphics or indicia printed thereon.

It will be understood that with some combinations of elements and materials, the microwave energy interactive element may have a grey or silver color this is visually distinguishable from the substrate or the support. However, in some instances, it may be desirable to provide a construct having a uniform color and/or appearance. Such a construct may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave interactive elements to the substrate, using a silver or grey toned substrate to mask the presence of the silver or grey toned microwave interactive element, using a dark toned substrate, for example, a black toned substrate, to conceal the presence of the silver or grey toned microwave interactive element, overprinting the metallized side of the substrate with a silver or grey toned ink to obscure the color variation, printing the non-metallized side of the substrate with a silver or grey ink or other concealing color in a suitable pattern or as a solid color layer to mask or conceal the presence of the microwave energy interactive element, or any other suitable technique or combination thereof.

It will be understood that in each of the various blanks and constructs described herein and contemplated hereby, a “fold line” can be any substantially linear, although not necessarily straight, form of weakening that facilitates folding therealong. More specifically, but not for the purpose of narrowing the scope of the present invention, a fold line may be a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; or any combination of these features.

A “tear line” can be any at least somewhat line-like arranged, although not necessarily straight, form of weakening that facilitates tearing therealong. More specifically, but not for the purpose of narrowing the scope of the present invention, a tear line may include: a slit that extends partially into the material along the desired line of weakness, and/or a series of spaced apart slits that extend partially into and/or completely through the material along the desired line of weakness, or any combination of these features.

As a more specific example, one type of conventional tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut or cut line. That is, it is within the scope of the present invention for each of the tear lines to be replaced with a continuous cut line, slit, or the like.

Furthermore, various exemplary blanks and constructs are shown and described herein as having fold lines, tear lines, score lines, cut lines, kiss cut lines, and other lines as extending from a particular feature to another particular feature, for example from one particular panel to another, from one particular edge to another, or any combination thereof. However, it will be understood that such lines need not necessarily extend between such features in a precise manner. Instead, such lines may generally extend between the various features as needed to achieve the objective of such line. For instance, where a particular tear line is shown as extending from a first edge of a blank to another edge of the blank, the tear line need not extend completely to one or both of such edges. Rather, the tear line need only extend to a location sufficiently proximate to the edge so that the removable strip, panel, or portion can be manually separated from the blank or construct without causing undesirable damage thereto.

While various examples of constructs are provided herein, it will be understood that any configuration of components may be used as needed or desired. The construct may be flexible, semi-rigid, rigid, or may include a variety of components having different degrees of flexibility. Additionally, it should be understood that the present invention contemplates constructs for single-serving portions and for multiple-serving portions. It also should be understood that various components used to form the constructs of the present invention may be interchanged. Thus, while only certain combinations are illustrated herein, numerous other combinations and configurations are contemplated hereby.

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is not intended nor is to be construed to limit the present invention or otherwise to exclude any such other embodiments, adaptations, variations, modifications, and equivalent arrangements of the present invention.

What is claimed is:

1. A sleeve for heating, browning, and/or crisping a food item in a microwave oven, comprising:
a base panel including a pair of opposite edges;
a first side panel and a second side panel, each respectively extending upwardly from the opposite edges of the base panel;
an inner top panel foldably joined to the first side panel;
an outer top panel foldably joined to the second side panel, the outer top panel extending substantially between the side panels, wherein the base panel, the first side panel, the second side panel, and at least one of the inner top panel and the outer top panel define an interior space;
a locking feature foldably joined to the outer top panel, the locking feature being received within a receptacle proximate to the first side panel; and
a microwave energy interactive element overlying at least one of the base panel, the first side panel, the second side panel, the inner top panel, and the outer top panel on a side of the respective panel facing the interior space.

2. The sleeve of claim 1, wherein the receptacle comprises a receiving slot positioned along a fold line adjoining the inner top panel and the first side panel.

3. The sleeve of claim 1, wherein the receptacle comprises a receiving slot in the inner top panel.

4. The sleeve of claim 1, wherein the receptacle comprises a receiving slot in the first side panel.

5. The sleeve of claim 1, wherein the locking feature is in a substantially contacting, facing relationship with the side of the first side panel facing the interior space.

6. The sleeve of claim 1, wherein the inner top panel and the outer top panel are in an at least partially overlapping, contacting relationship with respect to one another.

7. The sleeve of claim 1, wherein the inner top panel and the outer top panel are substantially parallel to the base panel.

8. The sleeve of claim 1, wherein the inner top panel extends substantially between the first side panel and the second panel.

9. The sleeve of claim 1, wherein the inner top panel extends partially between the first side panel and the second panel.

10. The sleeve of claim 9, further comprising a tear strip defined in the outer top panel.

11. The sleeve of claim 1, further comprising
a first support element extending downwardly from the first side panel, and
a second support element extending downwardly from the second side panel.

12. The sleeve of claim 1, wherein the microwave energy interactive element comprises a susceptor.

13. A blank for forming a microwave heating, browning, and/or crisping sleeve, comprising:
a plurality of adjoined panels, each panel having a first dimension extending in a first direction and a second dimension extending in a second direction perpendicular to the first direction, the plurality of panels including:
a base panel,
a first side panel and a second side panel, each being foldably joined to the base panel,
a first top panel joined to the first side panel along a fold line extending in the first direction, the fold line being interrupted by a slit,
a second top panel foldably joined to the second side panel,
a locking feature foldably joined to the second top panel, the locking feature being substantially aligned in the second direction with the slit; and
a microwave energy interactive element overlying at least one of the base panel, the first side panel, the second side panel, the first top panel, and the second top panel.

14. The blank of claim 13, wherein the slit has a dimension in the first direction sufficient to receive the locking feature.

15. The blank of claim 13, wherein the slit includes
a pair of substantially opposed converging oblique portions extending from the fold line towards the first top panel, and
a substantially linear portion extending substantially between the oblique portions.

16. The blank of claim 13, wherein the second dimension of the first top panel is approximately equal to the second dimension of the second top panel.

17. The blank of claim 13, wherein the second dimension of the first top panel is less than the second dimension of the second top panel.

18. The blank of claim 13, wherein the second top panel includes a tear strip defined by a plurality of slits in the second top panel.

19. The blank of claim 18, wherein the tear strip extends substantially in the first direction.

20. The blank of claim 13, wherein
the first side panel and the second panel are joined to the base panel along respective fold lines extending in the first direction, and
each fold line is interrupted by a substantially C-shaped slit extending into the base panel.

21. The blank of claim 13, wherein the microwave energy interactive element comprises a susceptor.

22. A method of packaging a food item to be heated, browned, and/or crisped in a microwave oven, comprising:
providing a blank including a plurality of panels, each panel having a first dimension extending in a first direction and a second dimension extending in a second direction perpendicular to the first direction, the plurality of panels including
a base panel,
a first side panel and a second side panel foldably joined to opposite edges of the base panel,
a first top panel joined to the first side panel along a fold line extending in the first direction, the blank including a receptacle proximate to the fold line,
a second top panel foldably joined to the second side panel,
a locking feature foldably joined to the second top panel, the locking feature being substantially aligned in the second direction with the receptacle, and
a microwave energy interactive material overlying at least a portion of at least one of the base panel, the first side panel, the second side panel, the first top panel, the second top panel, and the locking feature;
placing a food item on the base panel;
folding the first side panel and the second panel upwardly towards the food item;
folding the first top panel and the second panel over the food item, such that the first top panel and the second top panel are in an overlapping relationship; and
inserting the locking feature into the receptacle to form a sleeve containing the food item.

23. The method of claim 22, further comprising wrapping the sleeve containing the food item with an overwrap.

24. The method of claim 23, wherein the overwrap has an oxygen transmission rate of less than about 10 cc/m²/day/atm.
